(19) United States
(12) Patent Application Publication
(10) Pub. No.: US 2003/0148011 A1
(43) Pub. Date: Aug. 7, 2003

(54) Stabilizer for acidified milk beverages

(76) Inventors: Ralph M. Trksak, Manville, NJ (US); Jeffrey W. Foss, Erlanger, KY (US); Hozumi Tsubomoto, Takarazuka-City (JP); Hiroaki Fudaba, Minoh-City (JP)

Correspondence Address: David P. LeCroy, NATIONAL STARCH AND CHEMICAL COMPANY, P.O. Box 6500, Bridgewater, NJ, 08807-0500, US

(21) Appl. No.: 10/359,352

(22) Filed: Feb. 5, 2003

Related U.S. Application Data
(60) Provisional application No. 60/354,566, filed on Feb. 6, 2002.
(60) Provisional application No. 60/354,802, filed on Feb. 6, 2002.

(51) Int. Cl. C12C 1/00

(52) U.S. Cl. 426/590

(57) ABSTRACT

The present invention relates to the use of starch as a stabilizer in acidified milk beverages, the stabilizer syrups and beverages comprising the starch and the process for preparing them.

### CROSS REFERENCE TO RELATED APPLICATIONS

This application claims the benefit of U.S. Provisional Application Nos. 60/354,566 and 60/354,802, both of which were filed Feb. 6, 2002.

### BACKGROUND OF THE INVENTION

1. Technical Field

The present invention relates to the use of certain starches as stabilizers in acidified milk beverages, the stabilizer syrups and beverages comprising the starch and the process for preparing them.

2. Background Information

Non-starch polysaccharides (“gums”) such as pectin, carboxymethyl cellulose or soybean polysaccharides traditionally have been used in acidified milk beverages, particularly drinking yogurts, to prevent the precipitation of milk proteins, a phenomenon also know as “wheying-off”.

The milk protein (casein) has a roughly spherical sub-micelle aggregate structure held together by hydrophobic bonds and salt bridges. These sub-micelles, which are sterically stabilized by κ-casein “hairs”, destabilize and begin to coagulate at a pH of less than about 5.2. Destabilization is maximized at a pH of about 4.6, the isoelectric point of casein, which is a pH typical of fermented milk beverages, including drinking yogurts. A gum, such as high methoxy pectin, is traditionally added to such beverages in order to stabilize the beverage and prevent precipitation of the proteins. It is thought that the pectin adsorbs to the surface of the casein aggregates, probably by electrostatic attraction and acts as a dispersing agent, preventing coagulation by virtue of the adsorbed casein/pectin particle's electronic and/or steric properties.

Such gums are expensive ingredients, especially relative to starch. Replacement of gum is therefore desirable in order to reduce the cost of the yogurt. However, the removal or reduction of gums negatively impacts the stability of the beverage as well as other organoleptic and structural properties. Consumers demand that food products in which at least a portion of the gum has been removed retain the quality of the corresponding conventional products. Previous attempts to stabilize drinking yogurts with starch have indicated that starch must be added at levels that caused undesirable thickening/viscosity as well as unacceptable mouthfeel and taste.

Accordingly, there is an ongoing need to replace the more expensive components of acidified milk beverages such as gums, as well as to provide stability while maintaining acceptable organoleptic and structural properties.

### SUMMARY OF THE INVENTION

It has now been discovered that various starches, such as waxy starches including hydroxypropylated and succinylated types, starch acetates and starch phosphates, may be used as the substantially sole stabilizer in acidified milk beverages. As such, the present invention is directed towards starch products that are useful as stabilizers in acidified milk beverages. The acidified milk beverages of the present invention retain their stabilized character relative to traditional beverages that utilize a gum stabilizer.

The present invention is further directed to a process for preparing stabilizing syrup including the steps of mixing starch, sugar and water and then cooking the mixture to give a fully dispersed mixture. Stabilizing syrups prepared via this process are taught by the present invention. The invention is also directed to a process for preparing acidified milk beverages wherein the stabilizing syrup is blended with milk product solids, and the acidified milk beverages prepared thereby.

These and other objects of the present invention will become apparent to one skilled in the art from the following detailed description and examples below.

### DETAILED DESCRIPTION OF THE INVENTION

As previously noted, the present invention is directed to the use of various starches as substantially the sole stabilizer in stabilizing syrups and acidified milk beverages, particularly drinking yogurts.

All starches and flours (hereinafter “starch”) may be suitable for use herein. Cold temperature stable starches are particularly suitable. As defined herein, a cold temperature stable starch is a starch which can be formulated in 1% w/w amount in a milk beverage having a pH of less of between 3.9 to about 4.6, a solids content of less than 20%, and a viscosity increase of less than 300 centipoise (“cP”), particularly less than 200 cP, and more particularly less than 100 cP, wherein the viscosity is measured at 50 RPM at 4° C. over two weeks time.

Starches suitable for use herein may be derived from a native starch or flour. As used herein a native starch or flour is one as it is found in nature. Also suitable are starches and flours derived from a plant obtained by standard breeding techniques including crossbreeding, translocation, inversion, transformation or any other method of gene or chromosome engineering to include variations thereof. In addition, waxy starch or flours derived from a plant grown from artificial mutations and variations of the above generic composition, which may be produced by known standard methods of mutation breeding, are also suitable herein.

Typical sources for the starches and flours are cereals, tubers, roots, legumes and fruits. The native source can be corn, pea, potato, sweet potato, banana, barley, wheat, rice, sago, amaranth, tapioca, arrowroot, canna, sorghum, and waxy or high amylose varieties thereof. As used herein, the term “waxy” is intended to include a starch or flour containing at least about 95% by weight amylopectin and the term “high amylose” is intended to include a starch or flour containing at least about 40% by weight amylose. Low amylose and waxy starches are particularly suitable for use in the present application, with waxy starches being preferred. The term “starch” as used herein is intended to specify single starches as well as blends of the suitable starches described herein.

Suitable starches for use herein also include chemically modified starches, i.e., starch derivatives. Suitable modified derivatives include, without limitation, starch esters and ethers such as starch acetate and starch succinate. Such modified derivatives particularly suited in the present application include starch acetate derivatives treated with up to 10% w/w reagent on the starch, and preferably with up to 4% w/w reagent. Such modified derivatives particularly suited in the present application also include starch hydroxyalkylates, particularly hydroxypropylated starch treated with up to 25% w/w propylene oxide on starch, and preferably up to about 10% w/w propylene oxide. The preparation and properties of such starches are known and described in the art in, for example, R. L. Whistler, J. N. BeMiller, and E. F. Paschall, Starch Chemistry and Technology, 2^{nd} Ed., Academic Press, Inc., London, Chpt. 9, Sect 5, pp. 343-349 (1984), and R. L. Whistler and J. R. Daniel, Carbohydrates, Food Chemistry, 2^{nd} Ed., O. R. Fenenma Ed., Marcel Dekker, Inc., New York, Chpt. 3, p. 119 (1985).

One skilled in the art will recognize that degraded starches are useful in the present invention. However, non-degraded starches are preferred in that a lesser amount of non-degraded starch is required in the beverage than degraded starch. Further, degraded starches tend to negatively affect other characteristics of the beverage, such as taste, versus non-degraded starches.

A particularly useful process for the preparation of the phosphorylated starches is described in co-pending U.S. Ser. No. 09/633,832, filed Aug. 7, 2000, incorporated herein by reference. The process includes impregnating the desired starch with a phosphate reagent, and optionally, an oligosaccharide. From its fluidized state, the impregnated starch is then dried to a virtually anhydrous state, preferably one percent by weight of the starch or less, and heat-treated to effect phosphorylation. The impregnation of the starch by oligosaccharide and phosphate reagent may be done in any order. The pH of the resultant slurry can then be adjusted to between about 3 and about 12, preferably between about 6 and about 9.5.

“Phosphate reagent” as used herein includes any phosphate reagent used for phosphorylating starch, such as ortho-, pyro-, meta- and tripolyphosphates. Illustrative phosphate reagents are the alkali metal phosphates, such as sodium and potassium ortho-phosphate, phosphoric acid, phosphorus oxychloride, sodium and potassium tripolyphosphate, and sodium and potassium trimetaphosphate. The reagent may be a mono-, di- or trialkyl metal phosphate or combinations thereof. Sodium tripolyphosphate is particularly (“STP”) useful.

Impregnation by the phosphate reagent may be accomplished by adding the reagent in an amount of less than about 15% by weight of starch, preferably less than about 10%. The phosphate reagent may be added in the dry state to wet starch granules, or by dissolving the reagent in water to form an aqueous solution which is then mixed with the starch granules. These impregnation techniques are described in U.S. Pat. Nos. 4,166,173 and 4,216,310, incorporated herein by reference.

Any oligosaccharide may be suitable for use herein and may be derived from any native source such as those listed above. The source may be the same as or different from that of the starch component. As defined herein, oligosaccharide contains from one to twenty sugar units joined by glycosidic bonds. Oligosaccharide is intended to include monosaccharides, disaccharides, oligosaccharides, maize syrup solids, and malto dextrins. Oligosaccharide suitable for the present invention include, but are not limited to, debranched starches, maize syrup solids, dextrose, fructose, maltose, particularly maize syrup solids with a DE of from about 20 to 40. Although oligosaccharide is intended to include monosaccharides, these generally add color and/or flavor that may be undesirable in many industrial applications. Therefore, particularly suitable oligosaccharides for the present invention are those which contain at least two sugar units joined by glycosidic bonds.

Addition of the oligosaccharide to the starch may be achieved by adding the oligosaccharide dry or as an aqueous solution. In particular, the oligosaccharide may be added to agitated starch slurry, or starch may be added to a stirred, aqueous solution of the oligosaccharide. In addition, an aqueous solution of the oligosaccharide may be sprayed onto dry or wet starch granules.

The starch, impregnated with phosphate and optionally with oligosaccharides, is then subjected to a fluidized state and heat-treated to effect the phosphorylation. Though the heat treatment may be carried out in one step, it is preferably carried out in two steps. First, the impregnated starch is subjected to the fluidized state and dried at less than about 140° C., preferably between about 60° C. and about 140° C., and most preferably between about 100 and about 125° C., to virtually anhydrous conditions, preferably less than about 1% moisture content by weight of starch. Secondly, while still in the fluidized state, the dried product is heated to between about 100 and about 185° C., preferably between about 120 and about 140° C. for about 30 to about 300 minutes. At temperatures higher than about 150° C., the processing time is preferably less than about 45 minutes.

The fluidized state is achieved by vigorous mixing of the solid starch particles in vacuum or in a gas whereby a uniform distribution of starch throughout the vacuum or gas may be attained. Vigorous mixing may be accomplished by using air or gas, at or above atmospheric pressures in a fluidized bed reactor or by sufficient mechanical agitation. Where pressurized gas is used to effect the fluidized state, the velocity of the gas must achieve a minimum rate such that the particles are free to move and exhibit a “fluidized state.” The fluidized state results in very efficient heat transfer and allows the starch to rapidly dry to a virtually anhydrous state at low temperature.

Suitable starches also useful in the present invention include cold temperature stable starches that are known to be inherently low temperature solution stable, or starches that are genetically modified to favor the low temperature, solution stability phenotype. Such starches include, without limitation, waxy maize starches having at least one recessive sugary-2 allele. An example of such a starch includes waxy maize starch derived from a plant having endosperm tissue which is heterozygous, with either one or two doses, for the recessive sugary-2 allele, described further in U.S. Pat. No. 5,954,883, the disclosure of which is incorporated herein by reference. Another example includes starch derived from a waxy maize plant of a wxsu2 (homozygous) genotype and translocations, inversions, mutants and variants thereof, discussed in U.S. Pat. No. 4,428,972, the disclosure of which is incorporated herein by reference.

Physically modified starches derived from the foregoing suitable starches may also be suitable for use herein, including pregelatinized and converted starches. Pre-gelatinization techniques include drum drying and spray drying, including spray drying using the methods described in U.S. Pat. Nos. 4,280,851; 4,600,480; 5,131,953; and 5,149,799, and alcohol treatments as described in U.S. Pat. No. 4,465,702. Conversion (degradation) products derived from any of the starches, including fluidity or thin-boiling starches prepared by oxidation, enzyme conversion, acid hydrolysis, heat and or acid dextrinization, and/or sheared products may also be useful herein.

Any starch having suitable properties for use herein may optionally be purified by any method known in the art to remove starch off flavors (also known as “off-notes”) and colors that are native to the starch or created during starch modification processes. Suitable purification processes for treating the instant starches are disclosed in European Patent Application No. 93101520.0 (Publication No. 0 554 818) to Eden et al. Alkali washing techniques, for starches intended for use in either granular or pregelatinized form, are also useful and described in U.S. Pat. Nos. 4,477,480 to Seidel and 5,187,272 to Bertalan et al. Purification by the starches by extraction with a fluid in the supercritical or liquid phase is also useful and described in U.S. Ser. No. 60/317,572, filed Sep. 6, 2001, the disclosure of which is incorporated herein by reference.

Generally, suitable starches are used to prepare stabilizing syrups. These syrups are subsequently blended with a milk solids solution. A particularly useful process for preparing stabilizing syrup comprises mixing sugar, starch and water and cooking the mixture to give a fully dispersed mixture. As defined herein, a fully dispersed mixture indicates a mixture in which no starch granules are left intact.

Useful cooking techniques may include, without limitation, low temperature and long time processes (“LTLT”), high temperature and short time (“HTST”) processes, and ultra high temperature processes (“UHT”). LTLT pasteurization takes place at a minimum of about 63° C. for about 30 minutes, allowing starch hydration and cooking. Higher temperature processing covers a wide range of conditions and are described more fully in U.S. Pat. No. 6,247,507, the disclosure of which in incorporated herein by reference. Generally, HTST involves pasteurization at a minimum temperature of about 72° C. for about 15 seconds. Under UHT conditions, the product must typically reach a minimum temperature of about 138° C. for a minimum of about two seconds, more particularly from about 4 to about 6 seconds.

Cooking may be achieved by a variety of methods known in the art including, without limitation, tubular heat exchange, plate heat exchange, etc. A particularly useful cooking technique is via HTST pasteurization conducted, for example, in a tubular or plate heat exchanger at about 115° C. for about 3 seconds, or under such conditions that a fully dispersed syrup is obtained.

The resultant stabilizing syrup is then optionally stored or used directly for preparing acidified milk beverages. Preparation involves mixing the stabilizing syrup under low shear (mechanical stirring). The syrup is mixed in a ratio of about 10 to about 60 percent by weight with about 0 to about 3.5% fat and about 9 to about 17% milk solids product, which has been fermented to a pH of about 3.9 to about 4.6, and homogenized according to techniques known in the art. The ratio of stabilizing syrup to the fermented milk product solution can be adjusted according to processing limitations and the desired characteristics of the acidified milk product. The resultant acidified milk beverage may be further subjected to heat treatment in order to extend storage life. Flavoring, coloring and other ingredients characteristic of traditional acidified milk beverages may optionally be added to the acidified milk beverage of the present invention.

As used herein, the term “acidified milk beverage” is defined as a beverage having a total solids content of less than about 20%, a pH of between about 3.9 to about 4.6, and a Brookfield viscosity measured at 50 RPM and 4° C. of less than about 400 cP. More particularly, the beverage has a viscosity of less than about 300 cP. Even more particularly, the beverage has a viscosity of between about 100 cP and about 200 cP.

The starches of the present invention may be used to replace substantially all the gum traditionally used to stabilize acidified milk beverages. In order to adequately stabilize acidified milk beverages, typically about 0.3% by weight gum is used. Accordingly, the acidified milk beverages of the present invention contain less than about 0.15% by weight gum, particularly less than about 0.1% by weight gum, and more particularly less than about 0.05% by weight gum of the beverage.

In addition to stabilizing acidified milk beverages, certain starches of the present invention may desirably retain certain organoleptic and structural properties of the acidified milk beverages, particularly viscosity stability, mouthfeel and taste. For example, the acidified milk beverages of the present invention containing hydroxypropylated waxy corn starch substantially retain their viscosity stability, mouthfeel and flavor in comparison to a corresponding beverage containing 0.3% w/w of an industry standard pectin stabilizer.

The following examples will more fully illustrate the embodiments of this invention. In the examples, all parts and percentages are by weight and all temperatures in degrees Celsius unless otherwise noted.

### EXAMPLES

Procedures

Measurement of Viscosity Stability

The viscosity of the acidified milk beverages was measured with a Brookfield LV/DV-III viscometer equipped with a small sample adapter and a computer loaded with Brookfield's Rheocalc software (Brookfield Rheocalc for Windows—Brookfield Engineering Laboratories, Inc., Stoughton, Mass.). One ounce samples of the beverages stored at 4° C. were inverted once and then poured into the Brookfield Thermocel accessory (both accessory and a SC4-31 spindle were pre-chilled in ice). A 50-250 RPM scan was then conducted on the samples over approximately 2.5 minutes.

Measurement of Beverage Stability (also known as “Wheying-off”)

Digital photos were taken of each acidified milk beverage after 1, 7 and 14 days of storage at 4° C. The images were then analyzed using Sigma Scan Pro V 4.0 image analysis software by manual definition (tracing with the mouse) of the clear liquid region (or liquid separated from solids). A “trace measurement” was then run for total area, thereby defining the total number of pixels in the defined area. The percent wheying-off was determined based on the trace measurements.

Measurement of Organoleptic Properties

Each sample of acidified milk beverage was evaluated by an expert for mouthfeel and flavor on a scale of −4 to +4. Zero (0) is the value of the corresponding acidified milk beverage prepared according to the procedure described in Example 3, infra, and containing 0.3% of an industry standard pectin.

Mouthfeel describes the overall textural characteristics of the beverage as it is experienced in the mouth. A negative value for mouthfeel indicates the presence of factors such as mouth-drying and astringency as compared to the control beverage. A positive value indicates the presence of factors including the degree of mouth-coating and lubricity. A negative value for taste (flavor) indicates the presence of off-notes or masking of the dairy flavor or masking of sweetness as compared to the control beverage. A positive value indicates that the beverage has less masking of dairy flavor or sweetness compared to the control.

### DESCRIPTION OF STARCHES USED IN THE EXAMPLES

Starch A—Waxy maize starch.

Starch B—A total of 1000 parts waxy maize starch was introduced into a reaction vessel containing a solution of 18.75 parts sodium sulfate in 1500 parts water. The required amount of propylene oxide was then added (3% w/w in one case, 9% w/w in the other case) and the vessel sealed. The contents were allowed to react for 16 hours at 40° C. while the vessel was continuously tumbled to assure uniform suspension of the starch throughout the mixture. The pH of the resultant suspension was adjusted to 5.5 by the addition of a 25% sulfuric acid solution. The hydroxypropylated starch was recovered by filtration, washed two times with 1500 parts water and dried.

Starch C—A total of 100 parts waxy maize starch was slurried in 150 parts water and the pH was adjusted to 8.2 with 3% sodium hydroxide solution. The indicated amount of acetic anhydride (1% or 4% w/w) was slowly added while maintaining the pH between 7.8 and 8.2 with the above alkali. The reaction was complete when no further addition of alkali was necessary. The pH was adjusted to between 4.0 and 6.5 and the resulting derivative was recovered by filtration and washed two times with 150 parts water.

Starch D—A total of 100 parts waxy maize starch was slurried in 150 parts water and the pH was adjusted to 8.2 with 3% sodium hydroxide solution. The indicated amount of finely ground succinic anhydride (1% w/w on starch) was slowly added while maintaining the pH between 7.8 and 8.2 with the above alkali. The reaction was complete when no further addition of alkali was necessary. The pH was adjusted to between 4.0 and 6.5 and the resulting derivative was recovered by filtration and washed two times with 150 parts water.

Starch E—Several slurries were prepared by adding 3000 g of waxy corn starch to 3750 ml of water, followed by the addition of 75 or 150 g of sodium tripolyphosphate (STP) at 2.5% or 5% by weight on starch. The pH of each slurry was adjusted to 7.0 using 10% hydrochloric acid, stirred for about 10 minutes and filtered on a Buchner funnel. The resultant STP impregnated starch was then air-dried to a moisture content of about 10% and ground using a Prater mill.

A fluid bed reactor (obtained from Procedyne Corporation, New Brunswick, N.J.) was pre-heated to 115° C. and the impregnated starch was loaded into the reactor. The temperature was maintained at 115° C. until the moisture of the impregnated starch was less than 1%. Afterwards, in order to effect phosphorylation, the temperature of the reactor was increased to 127° C. and maintained for 60 minutes. The heat treatment for each level of STP treatment resulted in levels of 0.13% and 0.31% inorganic phosphorus content.

### Example 1—Preparation of the Stabilizing Syrup

Sugar (sucrose, 17.0% w/w) and starch (hydroxypropylated waxy maize starch, 2.0% w/w) were blended thoroughly and added to water (81.0% w/w) under high agitation. Using a tubular heat exchanger (Model 25-2S, available from Microthermics, Inc. Raleigh, N.C.) the mixture was preheated to 90° C. and then cooked at 115° C. for 3 seconds (HTST process).

### Example 2—Preparation of the Acidifed Milk Beverages

Non-fat dry milk powder was added to non-fat milk to achieve a solids level of 10%. The powder was mixed until dissolved. Using a tubular heat exchanger, the mixture was then preheated to 65° C., homogenized at 1500 psig, pasteurized at 93° C. for two minutes, and cooled to 43-44° C. The homogenized and pasteurized mixture was inoculated with yogurt culture (0.1%, “Jo-Mix® NM 1-20”, available from Danisco Cultor), incubated at 44° C. until a pH of 4.3 to 4.6 was obtained, and cooled to about 4° C. The curd of the acidified milk product was then broken up and then homogenized at 2500/500 psig to further reduce the particle size. The stabilizer syrup prepared according to Example 1 was cooled to 4° C., then blended with the acidified milk product in a 50:50 w/w ratio and agitated with a slight vortex for two minutes. The resultant beverages prepared via the foregoing procedure contained a total 1% w/w starch.

### Example 3—Properties of the Acidified Milk Beverages

A variety of acidified milk beverages were prepared according to the method described in Example 2. In addition, a “control” beverage was prepared by the method of Example 2, using a stabilizing syrup prepared via the method of Example 1, except that a pectin (Genu® Pectin type JMJ, available from CP Kelco, US, Inc., Wilmington, Del.) was substituted for the starch in a syrup formulation w/w % ratio of 0.6:17.0:82.4 (pectin:sucrose:water). This resulted in a total 0.3% percent gum beverage, the industry standard concentration.

The properties of each beverage containing the starches and an industry standard gum (the “control”) were measured according to the above Procedures. The results, listed in the Table below, indicate that beverages containing the starches of the present invention (Examples 3a-3e) have better stability as indicated by % wheying-off throughout the two week storage time of the beverages as compared to the control beverage (Example 3f). Moreover, in addition to exhibiting improved stability, the beverages of the present invention containing hydroxyalkylated starches (Examples 3b and 3c) substantially retain a number of desirable organoleptic properties characteristic of the control beverage (Example 3f) as demonstrated by similar mouthfeel, taste and viscosity stability.

PROPERTIES OF ACIDIFIED MILK BEVERAGES

| | | | | | Viscosity @ 50 | | | | |
|---|---|---|---|---|---|---|---|---|---|
| | | % Wheying-off | | | RPM | | | | |
| Example | Stabilizer Used | Day 1 | Day 7 | Day 14 | Day 1 | Day 14 | pH | Mouthfeel | Flavor |
| 3a | Starch A-Waxy base | 1.7 | 5.6 | 5.7 | 16.90 | 22.70 | 4.25 | +½ | −½ |
| 3b | Starch B-3%-PO | 0.0 | 4.2 | 6.9 | 19.00 | 23.60 | 4.04 | +1 | 0 |
| 3c | Starch B-9%-PO | 0.0 | 4.3 | 6.9 | 21.80 | 28.20 | 4.05 | +½ | 0 |
| 3d | Starch C-1% AA | 0.0 | 4.9 | 6.3 | 19.00 | 24.20 | 4.22 | +1 | −1 |
| 3e | Starch C-4% AA | 0.0 | 4.5 | 4.4 | 21.10 | 28.10 | 4.20 | +1 | −2 |
| 3f | Starch D-0.13% P | 0.0 | 0.0 | 5.1 | 94.20 | 91.20 | 4.20 | +3 | −1 |
| 3g | Starch E-0.31% P | 0.0 | 0.0 | 2.0 | 78.00 | 69.60 | 4.17 | +1½ | −4 |
| 3h | Starch E-0.31% P | 0.0 | 7.5 | 12.0 | 97.80 | 103.20 | 4.13 | +2 | −3 |
| 3I | Control | 5.4 | 10.6 | 14.7 | 5.90 | 7.12 | 4.23 | 0 | 0 |

What is claimed and desired to be secured by Letters Patent is:

1. A stabilizer for an acidified milk beverage comprising:
at least one starch, wherein the at least one starch is substantially the sole stabilizer in the beverage.

2. The stabilizer of claim 1 wherein the at least one starch is a substantially non-degraded starch.

3. The stabilizer of claim I wherein the at least one starch is a substantially non-crosslinked starch.

4. The stabilizer of claim I wherein the at least one starch is a low temperature solution starch.

5. The stabilizer of claim I wherein the at least one starch is selected from the group consisting of waxy starch, acetylated starch, succinylated starch, phosphorylated starch and hydroxyalkylated starch.

6. The stabilizer of claim I wherein the at least one starch is impregnated with a phosphate reagent.

7. The stabilizer of claim 6 wherein the phosphate reagent is sodium tripolyphosphate.

8. An acidified milk beverage comprising the stabilizer of claim 1.

9. The acidified milk beverage of claim 8 further comprising less than about 0.15% w/w gum.

10. The acidified milk beverage of claim 9 further comprising less than about 0.10% w/w gum.

11. The acidified milk beverage of claim 10 further comprising less than about 0.05% w/w gum.

12. A method of preparing a stabilizing syrup for use in acidified milk beverages comprising the steps of:
mixing starch, sugar and water components together,
cooking the mixed components to give a dispersed stabilizing syrup, and
blending the stabilizing syrup with milk product solids.

13. The method of preparing a stabilizing syrup according to claim 12 further comprising the step of blending the stabilizing syrup with milk product solids under low shear.

14. The method of preparing a stabilizing syrup according to claim 12 further comprising the step of cooking the mixed components under a high temperature and short time process.

15. The method of preparing a stabilizing syrup according to claim 12 further comprising the step of blending the stabilizing syrup with milk product solids in a ratio of about 10 to about 60 percent by weight with about 0 to about 3.5% fat and about 9 to about 17% milk solids product.

16. An acidified milk beverage prepared according to the method of claim 12.

17. The acidified milk beverage of claim 16 wherein the acidified milk beverage comprises less than about 0.15% w/w gum.

18. The acidified milk beverage of claim 17 wherein the acidified milk beverage comprises less than about 0.10% w/w gum.

19. The acidified milk beverage of claim 18 wherein the acidified milk beverage comprises less than about 0.05% w/w gum.
